(19) United States
(12) Patent Application Publication
(10) Pub. No.: US 2014/0279607 A1
(43) Pub. Date: Sep. 18, 2014

(54) ENTERPRISE ENVIRONMENTAL REPORTING SYSTEM

(71) Applicant: Zein Aied Sweis, Allen, TX (US)

(72) Inventor: Zein Aied Sweis, Allen, TX (US)

(21) Appl. No.: 14/204,532

(22) Filed: Mar. 11, 2014

Related U.S. Application Data
(60) Provisional application No. 61/778,313, filed on Mar. 12, 2013.

(51) Int. Cl. G06Q 30/00; G06Q 10/10

(52) U.S. Cl. CPC G06Q 30/018; G06Q 10/10
USPC 705/317

(57) ABSTRACT

An environmental data reporting system may include an application interface removably coupled to a server-side database through a communications network, the application interface operable to store and retrieve data from the server-side database. The server-side database may include a representation, which may include at least one entity component, at least one project component, at least one template component, at least one item component, at least one data group component, and the at least one variable component. The system may also include a data grid operable as a user interface to display and allow user-manipulation of at least one data group component.

### CROSS REFERENCE TO RELATED APPLICATION

This application claims the benefit under 35 U.S.C. §119(e) of U.S. Provisional Patent Application Ser. No. 61/778,313 filed on Mar. 12, 2013, entitled “Enterprise Environmental Reporting System,” which is incorporated by reference in its entirety.

### TECHNICAL FIELD

This application relates to data reporting and, more particularly, to data reporting in the environmental field.

### BACKGROUND

Business enterprises are typically legally obligated to submit reports on their effect on the environment. To illustrate, suppose an enterprise operates an industrial plant. The enterprise must create and submit periodic reports on the type and amount of pollutants emitted by the plant. The manual creation of these reports is often time-intensive. First, the enterprise may have to measure the pollutants (e.g. carbon dioxide (CO2), nitrous oxide (NOx), and volatile organic chemicals (VOCs)) emitted by each asset (e.g. boilers, flares, and tanks) in the plant. Second, various statistics must be compiled from these measurements. Third, the statistics must be placed into a report and the report must be filed.

Computer-based solutions exist for simplifying the process of creating and submitting the reports, but these existing solutions have several drawbacks. First, their user interfaces tend to be difficult to use. Second, they are often inflexible and cannot be customized to meet unique requirements posed by an enterprise's business or by uncommon regulations.

It would be desirable if a solution for environmental reporting existed which was both easier to use and more flexible than existing solutions.

### SUMMARY

Embodiments of the present disclosure generally provide an environmental data reporting system for business enterprises.

Embodiments of the present disclosure generally provide an environmental data reporting system, which may include an application interface removably coupled to a server-side database through a communications network, the application interface operable to store and retrieve data from the server-side database. The server-side database may include a representation, the representation having at least one entity component operable to represent an enterprise or a line of business within the enterprise, at least one project component operable to represent a geographic area or a site within the at least one entity component, at least one template component operable to represent a type of asset utilized by the at least one entity component, at least one item component operable to represent an individual asset instantiated from the at least one template component, at least one data group component operable to represent at least one variable component, and the at least one variable component operable to represent a characteristic of the at least one item component. The environmental data reporting system may also include a data grid operable as a user interface to display and allow user-manipulation of the at least one data group component. The data grid may display at least one record, where the at least one record includes a variable result for each of the at least one variable component in each of the at least one data group component. The variable result may be manually entered by a user, calculated based on an expression, determined through integration with an external third-party system, or made equivalent to a second variable result. The at least one item component of the system may be inactive and if inactive may be excluded from display in the data grid. The application interface of the system may also include a user interface operable to receive user inputs to the system. The user interface may include an item panel, a template panel, and a data group panel. The item panel may display the at least one project component and the at least one item component of the at least one entity component, and the item panel may have folders to contain the at least one item component and operable to organize the at least one project component. The template panel may display the at least one template component of the at least one entity component, and the template panel may have template categories to contain the at least one template component and operable to organize the at least one template component. The data group panel may display the at least one data group component when the at least one item component or the at least one template component is selected, and the data group panel may have tabs to contain the at least one data group component and operable to organize the at least one data group component. The user interface may be operable to receive user input to create, organize, filter or edit the at least one item component, the at least one template component or the at least one data group component.

Embodiments of the present disclosure may further provide an environmental data reporting system which may include a non-transient computer readable medium encoded with instructions that, when executed on a processor, instruct the processor to perform operations which may include establishing a connection between an application interface of the system and a server-side database of the system through a communications network, the application interface may include a user interface operable to receive user inputs to the system; identifying an entity via user input; creating a project under the entity via user input; creating an item under the project via user input to represent an asset using a template, the item may include at least one data group having at least one variable defined from the template; generating a data grid of the at least one data group; displaying at least one record, the at least one record may include a variable result for each of the at least one variable in each of the at least one data group; populating the variable results; sensing changes made to the variable results for each of the at least one variable in each of the at least one data group; automatically and dynamically determining the variable results based on the sensed changes; customizing the data grid by filtering the at least one record based on user input; and generating a report based on the data grid. The instructions may be further operable to cause the processor to perform operations, which may include populating the variable result for each of the at least one variable in each of the at least one data group. The manner in which populating the variable result occurs may be selected from the group including manually entering the variable result, calculating the variable result based on an expression, determining the variable result through integration with an external third-party system, or making the variable result equivalent to a second variable result. The instructions may be further operable to cause the processor to perform operations, which may include creating at least one additional data group within the item. The instructions may be further operable to cause the processor to perform operations, which may include creating at least one additional variable within the data group; creating at least one additional record within the data grid; searching the server-side database based on user-defined search criteria and displaying the records meeting the user-defined search criteria in the data grid; inactivating the item to hide the item from data grid; or determining if there is a modification of the variable result since the variable result was displayed in the data grid, displaying a notification of the modification; and providing the option to change the variable result, overwrite the modification or accept the modification.

Other embodiments of the present disclosure may provide an environmental data reporting system, which may include a non-transient computer readable medium encoded with instructions that, when executed on a processor, instruct the processor to perform operations, which may include establishing a connection between an application interface of the system and a server-side database of the system through a communications network; rendering a representation of an enterprise operation, the representation which may include at least one entity, at least one project, at least one template, at least one item, at least one data group, and at least one variable; displaying a user interface via the application interface operable to receive user inputs to the system, the user interface which may include an item panel, a template panel, and a data group panel; generating a data grid of the at least one data group; displaying at least one record, the at least one record which may include a variable result for each of the at least one variable in each of the at least one data group; populating the variable results; sensing changes made to the variable results for each of the at least one variable in each of the at least one data group; automatically and dynamically determining the variable results based on the sensed changes; customizing the data grid by filtering the at least one record based on user input; and generating a report based on the data grid. The instructions may be further operable to cause the processor to perform operations selected from the group, which may include organizing the at least one item, the at least one template or the at least one data group; filtering the at least one item, the at least one template or the at least one data group; and editing the at least one item, the at least one template or the at least one data group. The instructions may also be further operable to cause the processor to perform operations which may include displaying the at least one project and the at least one item in the item panel; organizing the at least one item in folders; displaying the at least one template in the template panel; organizing the at least one template in template categories; displaying the at least one data group in the data group panel when the at least one item or the at least one template is selected; and organizing the at least one data group in tabs.

Other technical features may be readily apparent to one skilled in the art from the following figures, descriptions and claims.

### BRIEF DESCRIPTION OF DRAWINGS

For a more complete understanding of the present invention and the advantages thereof, reference is now made to the following Detailed Description taken in conjunction with the accompanying drawings, in which:

FIG. 1 depicts a system for enterprise environmental reporting in accordance with an exemplary embodiment of the present invention;

FIG. 2 depicts an internal representation of an enterprise's operations in accordance with an exemplary embodiment of the present invention;

FIG. 3 depicts a Data Grid showing Records for a Data Group in accordance with an exemplary embodiment of the present invention;

FIG. 4 depicts a user interface for working with an Entity in accordance with an exemplary embodiment of the present invention;

FIG. 5 depicts an exemplary data flow for setting up an Entity with Templates and Projects and Items;

FIG. 6 depicts a series of user interfaces for implement the step of creating and seeding a new Template and Item shown in FIG. 5;

FIG. 7 depicts a series of user interfaces for adding, deleting, and editing Variables, Templates, and Data Groups; and

FIG. 8 depicts a user interface for looking-up variable values from different Templates and Data Groups.

### DETAILED DESCRIPTION

In the following discussion, numerous specific details are set forth to provide a thorough explanation. However, such specific details are not essential. In other instances, well-known elements have been illustrated in schematic or block diagram form. Additionally, for the most part, specific details within the understanding of persons of ordinary skill in the relevant art have been omitted.

With reference to FIG. 1, depicted is a system 100 for enterprise environmental reporting in accordance with an exemplary embodiment of the present invention. System 100 may offer its functions through a web-based computer application. A user's device may access system 100 through communications link 102, which may be an Internet connection.

System 100 may have application interface 104, which may be a web-based interface to system 100. System 100 may also have server-side database 106, which may be a relational database. Application interface 104 may store and retrieve data from server-side database 106.

With reference to FIG. 2, depicted is an internal representation 200 of an enterprise's operations in accordance with an exemplary embodiment of the present invention. Representation 200 may include Entity 202, Projects 204, Templates 206, Items 208, Data Groups 210, and Variables 212. Entity 202 may represent the enterprise itself (e.g. XYZ Corporation) or a line of business within the enterprise (e.g. Chemical Manufacturing Unit, Refining Unit, Upstream Production Unit). In the latter case, other lines of business may be represented by their own Entities. Entity 202 may have one or more Projects 204 representing geographic areas or sites within Entity 202.

Templates 206 may be definitions of a type of asset utilized by the enterprise. For example, all of Entity 202's boilers may share Boiler Template 206A. Likewise, all heaters may share Heater Template 206B, all fixed roof tanks may share Fixed Roof Tank Template 206C, all flares may share Flare Template 206D, and so on.

The individual assets in Projects 204 may be represented by Items 208 instantiated from Templates 206. Thus, Boilers 208A, 208B, and 208C may represent three distinct boilers utilized by Project 204A, but may all be instantiated from Boiler Template 206A. In the preferred embodiment, each Item 208 is instantiated from exactly one Template 206. An Item 208 may have documents attached to it, similar to an electronic mail message. For example, a Microsoft Word Document containing a report on the boiler represented by Boiler 208A may be attached to Boiler 208A.

Representation 200 may contain a list of dates on which each of Items 208 became active and inactive. An Item 208 may become active when its corresponding asset is put into use and become inactive when its corresponding asset is no longer in use. By recording when Items 208 are active and inactive, inactive Items 208 may be excluded from displayed data. Recording an Item 208 as inactive may be preferable to deleting the Item 208 because the data of an inactive Item 208 may still be retained.

A Template 206 may have one or more Data Groups 210. Data Groups 210 may be collections of one or more related Variables 212, with each Variable 212 representing a property of Items 208 instantiated from the Template 206. As an example, Emissions Data Group 210A may be a Data Group 210 of Boiler Template 206A. Emissions Data Group 210A may contain Project Name Variable 212A, Item Name Variable 212B, Start Date Variable 212C, End Date Variable 212D, CO2 Emissions Variable 212E, NOx Emissions Variable 212F, and VOC Emissions Variable 212G.

Variables 212A-212D may be default Variables 212 for every Data Group 210. Variables 212A-212D may be used to uniquely identify each Record of the Data Group 210, as will be discussed below with reference to FIG. 3. Variables 212E-212G may be unique to Data Group 210A, respectively representing the CO2, NOx, and VOC emitted by a Boiler Item 208 instantiated from Boiler Template 206A.

A Data Grid may be the primary user interface for viewing and interacting with data. With reference to FIG. 3, depicted is a Data Grid 300 showing Records 302-306 for Data Group 210A in accordance with an exemplary embodiment of the present invention. A collection of values for each Variable in a Data Group may be called a Record. As illustrated, Data Group 210A has three Records, Records 302, 304, and 306. A Record may consist of one value, called a Variable Result, for each Variable in the Data Group. To distinguish between Records, each Data Group may have the default Variables of Project Name, Item Name, Start Date, and End Date, which respectively identify the Project, Item, Start Date, and End Date of the Record.

In Data Group 210A, Record 302 may store the emissions for a Boiler with Item Name 302B in the Project with Project Name 302A, from date 302C to date 302D. Variable Results 302E, 302F, and 302G may respectively contain the CO2, NOx, and VOC emitted by that Boiler between those dates. Records 304 and 306 may store the emissions for the same Boiler between different dates, or the emissions for a different Boiler.

Data Grid 300 may present Records 302-306 of Data Group 210A in a grid format. The top row of Data Grid 300 may identify the Variables 212A-212G of Data Group 210A. Records 302-306 may be shown as rows in Data Grid 300. The Variable Result for a particular Record and a particular Variable may be shown at the intersection of the row for the Record and the column for the Variable.

Data Grid 300 may permit a user to manually enter Variable Results. A user may sort and group Data Grid 300 based on Variable Results. A user may also search the server-side database based on user-defined search criteria, and only Records with Variable Results that meet the search criteria may be appear in Data Grid 300.

Some Variable Results may be defined as calculated based on an expression. When the value of a Variable Result is changed, any calculated Variable Results in Data Grid 300 that use that Variable Result in an expression may automatically refresh their values.

With reference to FIG. 4, depicted is a user interface 400 for working with an Entity in accordance with an exemplary embodiment of the present invention. After creating and naming a new Entity, a user may use user interface 400 to define the contents of the Entity. User interface 400 may be divided into Item Panel 402, Template Panel 404, and Data Group Panel 406.

Item Panel 402 may provide a tree view showing the Projects and Items in the entity. The root level of the tree may be the Projects 402A of the Entity. The lower levels of the tree may contain the Items 402B in the Projects. To further organize Item Panel 402, a user may create and name Folders 402C as desired. Items 402B may be placed within Folders 402C to organize a Project. A user may drag and drop Items 402B and Folders 402C to different positions in the tree.

Template Panel 404 may provide a tree view showing the Templates 404A in the entity. Template Panel 404 may additionally include Template Categories 404B, which are similar to Folders 402C in Item Panel 404. A user may create and name Template Categories 404B as desired. A Template 404A may be placed into a Template Category 404B by dragging and dropping. In an embodiment, Template Categories 404B may be restricted to the root level of Template Panel 404. Thus, a user may be unable to place a Template Category 404B within another Template Category 404B.

A user may edit an Item 402B or Template 404A by selecting it respectively from Item Panel 402 or Template Panel 404. When an Item 402B or a Template 404A is selected, Data Group Panel 406 may be updated to show the Data Groups 406A of the selected Item 402B or Template 404A. Each Data Group 406A may be shown in a separate tab. A user may view and edit the various different Data Groups 406A by selecting the tab for that Data Group 406A.

Data Grid 408 may display the Variables 406B of the selected Data Group 406A. Data Grid 408 may follow the same format as Data Grid 300 in FIG. 3. Each column in Data Grid 408 may represent a different Variable 406B, with the name of the Variable 406B at the top of the column. Each row in Data Grid 408 may represent a different Record 406C of the selected Data Group 406A.

From Data Group Panel 406, a user may create a new Data Group 406A, which may then appear as a new tab. From Data Group Panel 406, the user may also rearrange the tabs of the Data Groups 406A, change the name of an existing Data Group 406A, delete an existing Data Group 406A, and create a duplicate of an existing Data Group 406A.

To create a new Item 402B, a user may drag a Template 404A from Template Panel 404 to Item Panel 402. A user may alternately right-click Item Panel 402 and choose to add a new item. In either case, the user may provide a name, description, and item code for the new item.

Item Panel 402 may be filtered to display only Items 402B which were instantiated from a particular Template 404A. For example, to view only boilers a user may filter Item Panel 402 to display only Items instantiated from a Boiler Template.

A user may edit an Item 402B by selecting it in Item Hierarchy Window 402. When editing an Item 402B, a user may rename it, change its description, record it as inactive as of a particular date, edit its attachment, or delete it.

The system may be accessed by multiple users concurrently, creating a possibility that two users may attempt to change a Variable Result at the same time. Whenever a user attempts to change an existing value, the system may check to see if that value was modified since it was last displayed to the user. If so, the value may have been changed by another user in the meantime. The first user may be notified with an identification of the other user and the options to cancel the change or overwrite the other user's change.

FIG. 5 depicts a typical data flow for setting up a site (Project) under an existing Entity. At Decision Block 504, the system checks to determine if Template name already exists. If Template exists, then the system displays a message and stops the transaction at Block 503. Otherwise, the user creates a new Template at Block 505, using the process graphically shown using the user interfaces of FIG. 6.

As shown in FIG. 6, the user right clicks on the Template panel 404 (FIG. 4) and selects New Template option, which displays window 601. The user enters the Template name (e.g., Natural Gas Boiler) and other basic information and saves the content under the Natural Gas Boiler. The user then clicks on Natural Gas Boiler in Template Panel 404 of FIG. 4 and selects to add new Data Groups inside that template, which displays window 602. Using display window 602, the user enters the Data Group Name (e.g., Fuel Usage), along with a description of the new Data Group. The new Fuel Usage Data Group is accessible under the Fuel Usage tab 406 shown in FIG. 4. New Variables are entered into the new Data Group using a Manage Variables button. The User can create as many Templates as needed. When a Template is ready at Decision Block 506, that template can be used for a Project.

Specifically, in parallel at 502, the user creates a new Project at Block 512 to represent the environment site under which assets exist and for which data for those assets have to be gathered and maintained. Under newly the created Project, the user creates an item (ex. Boiler 101) to represent a specific asset (ex. Boiler) using window 603 of FIG. 6 and by drop dragging the corresponding Template (ex. Natural Gas Boiler) at Block 513. Now item (Boiler 101) is created with seeded Data Groups and Variables as was defined in parent Template (ex. Natural Gas Boiler).

Different Templates might require additional Data Groups at Decision Block 507, which the user can add Data Groups, as needed, at Block 508 using window 602 of FIG. 6. The system checks if Data Group name already exists at Decision Block 509, and if so, stops the transaction at Block 514. Otherwise a new Data Group is created at Block 510 and the user can add variables as necessary at Block 511.

When creating a new Variable, user must specify the type of variable as: a Lookup Variable (Block) 520, a Calculated Variable (Block 530), a Direct Entry (Block) 540, or an Integrated 3^{rd} Party Variable (Block 550). Based on selected Variable type, the system will behave differently.

A Lookup Variable signifies that the source data for that Variable Result will be another Data Group Variable. Therefore, the system will prompt user to define a Source Template and Data Group at Block 521 using Filters 801 of Window 800 of FIG. 8. Additional filters 802 of Window 800 can be applied on the source Data Group at Decision Block 522 and Block 523.

Window 800 and Filters 801 and 802 therefore provide a powerful look-up functionality that allows the user to lookup values from other Templates or Data Groups. The user selects a destination Template, Data Group, and Variable. (Generally, the destination is the location where the Variable Result will be looked-up from.) The user specifies the Begin Data and the End Date range where the lookup value will be filtered on. The user also specifies the Destination Project name filter and item name filter. This will help further narrow the Item and Project on which the destination data will be filtered. The user can also specify other filters based on other Variables within the same destination Data Group.

A Calculated Variable, signifies that Variable Result is calculated based on data from other Variables. Therefore the user must define the calculation details by invoking the Expression Editor 720 of FIG. 7 at Block 531. Setting up the calculation or Expression at Block 532, requires specifying Variables (Fields), Operators, Constants and/or built-in functions using Windows 720A and 720B of FIG. 7. Information and a description are displayed when highlighting Variables (Fields), Operators, Constants and/or built-in functions in a separate Panel 720C of FIG. 7. When the user clicks on the OK button shown in FIG. 7, the Data Grid displays all calculated results for the Variable immediately, such that the user does not have to run a report to be able to see the Variable Results. The user can then filter the records to be display in the Data Grid by selecting a data range for the current Data Group using Window 710

A Direct Entry Variable signifies that user will manually enter the value for that variable directly into the system at Block 541.

An Integrate with 3^{rd} Party Variable, signifies that data for this Variable will be an external data feeding into this system using special setup and API. To establish connection with external 3^{rd} Party System, the External Gateway must be setup at Block 551.

Variables and Variable Results are displayed in the Data Grid at Block 560 and Window 700 of FIG. 7. Variable Results are associated with Items. Data Grid is a flexible representation of data and can be filtered by a date range in Window 710 or grouped by Columns in Window 700. Data can be directly entered in the Data Grid by clicking in the Data Grid in Window 703. Any line in the Data Grid with a Begin Date and an End Date is a record and a user can start adding records inside the Data Grid using Window 700. These records contain results/values collected for variables for a certain Item in the Project. A user can drag a Template from the right side of Window 700 to the left side tree panel to an instantiate an Item (ex: Boiler 101). In addition, the user can drag any Variable in the current Data Group into Bar 701 above the desired column to group records by that selected Variable. The system then automatically displays aggregate information for the rest of the Variables in that group (ex: Sums, Averages, Minimums, Maximums, Counts).

It is noted that the embodiments disclosed are illustrative rather than limiting in nature and that a wide range of variations, modifications, changes, and substitutions are contemplated in the foregoing disclosure and, in some instances, some features of the present invention may be employed without a corresponding use of the other features. Many such variations and modifications may be considered desirable by those skilled in the art based upon a review of the foregoing description of various embodiments.

What is claimed is:

1. An environmental data reporting system comprising:
an application interface removably coupled to a server-side database through a communications network, the application interface operable to store and retrieve data from the server-side database;
the server-side database further comprising a representation, the representation comprising:
at least one entity component operable to represent an enterprise or a line of business within the enterprise;
at least one project component operable to represent a geographic area or a site within the at least one entity component;
at least one template component operable to represent a type of asset utilized by the at least one entity component;
at least one item component operable to represent an individual asset instantiated from the at least one template component;
at least one data group component operable to represent at least one variable component; and
the at least one variable component operable to represent a characteristic of the at least one item component.

2. The system of claim 1, the environmental data reporting system further comprising:
a data grid operable as a user interface to display and allow user-manipulation of the at least one data group component.

3. The system of claim 2, wherein the data grid displays at least one record; and wherein the at least one record comprises a variable result for each of the at least one variable component in each of the at least one data group component.

4. The system of claim 3, wherein the variable result is: manually entered by a user, calculated based on an expression, determined through integration with an external third-party system, or made equivalent to a second variable result.

5. The system of claim 2, wherein the at least one item component is active or inactive.

6. The system of claim 5, wherein when the at least one item component is inactive, the at least one item component is excluded from the data grid.

7. The system of claim 1, wherein the application interface further comprises a user interface operable to receive user inputs to the system.

8. The system of claim 7, wherein the user interface further comprises:
an item panel;
a template panel; and
a data group panel;
wherein the item panel displays the at least one project component and the at least one item component of the at least one entity component, the item panel having folders to contain the at least one item component and operable to organize the at least one project component;
wherein the template panel displays the at least one template component of the at least one entity component, the template panel having template categories to contain the at least one template component and operable to organize the at least one template component; and
wherein the data group panel displays the at least one data group component when the at least one item component or the at least one template component is selected, the data group panel having tabs to contain the at least one data group component and operable to organize the at least one data group component.

9. The system of claim 8, wherein the user interface is operable to receive user input to create, organize, filter or edit the at least one item component, the at least one template component or the at least one data group component.

10. An environmental data reporting system comprising a non-transient computer readable medium encoded with instructions that, when executed on a processor, instruct the processor to perform operations comprising:
establishing a connection between an application interface of the system and a server-side database of the system through a communications network, the application interface comprising a user interface operable to receive user inputs to the system;
identifying an entity via user input;
creating a project under the entity via user input;
creating an item under the project via user input to represent an asset using a template, the item comprising at least one data group having at least one variable defined from the template;
generating a data grid of the at least one data group;
displaying at least one record, the at least one record comprising a variable result for each of the at least one variable in each of the at least one data group;
populating the variable results;
sensing changes made to the variable results for each of the at least one variable in each of the at least one data group;
automatically and dynamically determining the variable results based on the sensed changes;
customizing the data grid by filtering the at least one record based on user input; and
generating a report based on the data grid.

11. The system of claim 10, wherein the instructions are further operable to cause the processor to perform operations comprising populating the variable result for each of the at least one variable in each of the at least one data group; wherein the populating is selected from the group comprising:
manually entering the variable result, calculating the variable result based on an expression, determining the variable result through integration with an external third-party system, or making the variable result equivalent to a second variable result.

12. The system of claim 10, wherein the instructions are further operable to cause the processor to perform operations comprising creating at least one additional data group within the item.

13. The system of claim 10, wherein the instructions are further operable to cause the processor to perform operations comprising creating at least one additional variable within the data group.

14. The system of claim 10, wherein the instructions are further operable to cause the processor to perform operations comprising creating at least one additional record within the data grid.

15. The system of claim 10, wherein the instructions are further operable to cause the processor to perform operations comprising searching the server-side database based on user-defined search criteria and displaying the records meeting the user-defined search criteria in the data grid.

16. The system of claim 10, wherein the instructions are further operable to cause the processor to perform operations comprising inactivating the item to hide the item from the data grid.

17. The system of claim 10, wherein the instructions are further operable to cause the processor to perform operations comprising:
determining if there is a modification of the variable result since the variable result was displayed in the data grid;
displaying a notification of the modification; and
providing the option to change the variable result, overwrite the modification or accept the modification.

18. An environmental data reporting system comprising a non-transient computer readable medium encoded with instructions that, when executed on a processor, instruct the processor to perform operations comprising:
establishing a connection between an application interface of the system and a server-side database of the system through a communications network;
rendering a representation of an enterprise operation, the representation comprising:
at least one entity;
at least one project;
at least one template;
at least one item;
at least one data group; and
at least one variable;
displaying a user interface via the application interface operable to receive user inputs to the system, the user interface comprising:
an item panel;
a template panel; and
a data group panel;
generating a data grid of the at least one data group;
displaying at least one record, the at least one record comprising a variable result for each of the at least one variable in each of the at least one data group;
populating the variable results;
sensing changes made to the variable results for each of the at least one variable in each of the at least one data group;
automatically and dynamically determining the variable results based on the sensed changes;
customizing the data grid by filtering the at least one record based on user input; and
generating a report based on the data grid.

19. The system of claim 18, wherein the instructions are further operable to cause the processor to perform operations selected from the group comprising:
organizing the at least one item, the at least one template or the at least one data group;
filtering the at least one item, the at least one template or the at least one data group; and
editing the at least one item, the at least one template or the at least one data group.

20. The system of claim 18, wherein the instructions are further operable to cause the processor to perform operations comprising:
displaying the at least one project and the at least one item in the item panel;
organizing the at least one item in folders;
displaying the at least one template in the template panel;
organizing the at least one template in template categories;
displaying the at least one data group in the data group panel when the at least one item or the at least one template is selected; and
organizing the at least one data group in tabs.
